(19) United States
(12) Patent Application Publication
(10) Pub. No.: US 2015/0275739 A1
(43) Pub. Date: Oct. 1, 2015

(54) EXHAUST GAS HEAT RECOVERY APPARATUS

(71) Applicant: TOYOTA JIDOSHA KABUSHIKI KAISHA, Toyota-shi (JP)

(72) Inventors: Takato ISHIHATA, Takahama-shi (JP); Toshio MURATA, Toyota-shi (JP); Yuichirou HIRATA, Miyoshi-shi (JP); Yukihisa MATSUDA, Nagoya-shi (JP); Tadashi NAKAGAWA, Miyoshi-shi (JP)

(73) Assignee: TOYOTA JIDOSHA KABUSHIKI KAISHA, Toyota-shi (JP)

(21) Appl. No.: 14/663,904

(22) Filed: Mar. 20, 2015

(30) Foreign Application Priority Data
Mar. 25, 2014 (JP) 2014-062478

(51) Int. Cl. F01N 13/08; F02G 5/02

(52) U.S. Cl. CPC F01N 13/08; F02G 5/02; F01N 2390/08

(57) ABSTRACT

A heat recovery unit is disposed in second piping branching from first piping in which an exhaust gas from an engine flows. An actuator driving a valve member of the first piping is arranged to be out of contact with a flow path for an engine coolant.

### INCORPORATION BY REFERENCE

The disclosure of Japanese Patent Application No. 2014-062478 filed on Mar. 25, 2014 including the specification, drawings and abstract is incorporated herein by reference in its entirety.

### BACKGROUND OF THE INVENTION

1. Field of the Invention

The invention relates to an exhaust gas heat recovery apparatus.

2. Description of Related Art

Techniques for raising a temperature of an engine coolant by using heat of an exhaust gas from an engine are known. For example, Japanese Patent Application Publication No. 2007-100665 (JP 2007-100665 A) discloses an exhaust gas passage structure for an internal combustion engine in which a thermostat is arranged on a downstream side of a radiator in coolant piping from an engine. Japanese Patent Application Publication No. 2006-312884 (JP 2006-312884 A) discloses an exhaust gas heat recovery apparatus that is provided with a heat exchange path which is provided with a heat exchanger and a bypass path which bypasses the heat exchanger and switches a flow path for an exhaust gas by controlling a valve element disposed in the bypass path. Japanese Patent Application Publication No. 2008-101481 (JP 2008-101481 A) discloses an exhaust gas system structure in which thermal expansion of wax causes a pressing rod to extend and a valve of a heat exchanger shell to be at a full-open position in a case where a coolant has a predetermined or higher temperature.

If switching between performance and non-performance of exhaust heat recovery (operation for allowing exhaust gas heat to act on a heat medium such as the engine coolant) depends on the temperature of the coolant as described above, the switching becomes switching based on the temperature of the coolant. In other words, there is room for improvement to allow switching between recovery and non-recovery of the exhaust heat in conditions other than the temperature of the coolant.

### SUMMARY OF THE INVENTION

The invention is to allow switching between performance and non-performance of exhaust heat recovery by decreasing an impact of heat of a heat medium.

A first aspect of the invention relates to an exhaust gas heat recovery apparatus including first piping in which an exhaust gas from an engine flows, second piping branching from the first piping and including a heat recovery unit allowing heat of the exhaust gas to act on a heat medium, a valve member that adjusts a flow rate of the exhaust gas to the second piping, and a driving member arranged to be out of contact with a flow path for the heat medium and energized to heat wax to change the volume of the wax so that the valve member is driven.

In this exhaust gas heat recovery apparatus, the driving member is energized to heat the wax, change the volume of the wax, and drive the valve member. The flow rate of the exhaust gas from the engine to the second piping is adjusted by the driving of the valve member. The second piping is provided with the heat recovery unit. When the flow rate of the exhaust gas to the second piping is increased, an increased amount of exhaust gas heat can be allowed to act on the heat medium (for example, an engine coolant).

The driving member is arranged to be out of contact with the flow path for the heat medium. Accordingly, an impact of the heat from the heat medium on the volume change of the wax can be decreased. The driving of the valve member can be controlled based on the volume change of the wax caused by the energization and the heating so that switching is allowed between performance and non-performance of exhaust heat recovery.

The exhaust gas heat recovery apparatus may include a heat conduction member that transfers heat from a heat source to the wax.

The wax can be heated by using the heat from the heat source. For example, electric power consumption for the energization can be suppressed when an expanded state of the wax is to be maintained.

The heat source may be the first piping.

In this case, the heat of the exhaust gas that flows in the first piping can be efficiently transferred to the wax.

The heat conduction member may have a surrounding portion surrounding the wax.

When the heat conduction member surrounds the wax, the heat can be more efficiently transferred to the wax than in a structure in which the wax is not surrounded. To “surround” refers to, for example, a state where a member in which the wax is accommodated is surrounded in a closed curve shape or in a closed surface shape.

The driving member may be configured to control the valve member so that a temperature rise of the wax decreases the flow rate of the exhaust gas to the second piping.

In a state where the temperature of the wax increases, the flow rate of the exhaust gas to the second piping is small. In other words, the heating of the wax can be efficiently supplemented by the heat of the heat source and the electric power consumption can be reduced in a state where the amount of the heat recovered by the heat recovery unit is small.

The exhaust gas heat recovery apparatus may include a heat insulation member that insulates the wax from the outside.

The wax is insulated from the outside by the heat insulation member, and thus an impact of external heat on the volume change of the wax can be decreased.

According to the invention that has the configuration described above, the impact of the heat of the heat medium can be decreased and the switching between the performance and non-performance of the exhaust heat recovery can be allowed.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic configuration diagram illustrating an exhaust gas heat recovery apparatus according to a first embodiment of the invention;

FIG. 2 is a cross-sectional view illustrating the exhaust gas heat recovery apparatus according to the first embodiment of the invention; and

FIG. 3 is a cross-sectional view of the exhaust gas heat recovery apparatus according to the first embodiment of the invention taken along line 3-3 in FIG. 2.

### DETAILED DESCRIPTION OF EMBODIMENTS

An exhaust gas heat recovery apparatus according to a first embodiment of the invention will be described with reference to accompanying drawings.

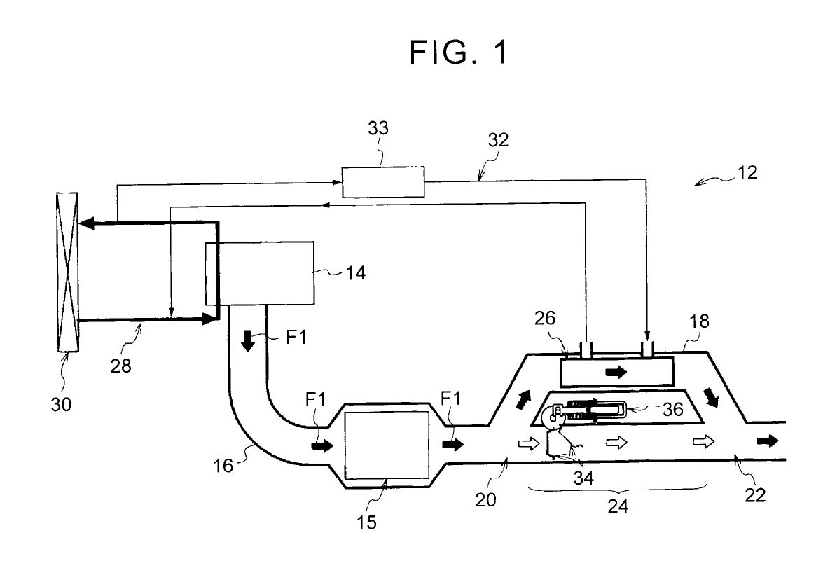

An exhaust gas heat recovery apparatus 12 according to the first embodiment of the invention is illustrated in FIG. 1. The exhaust gas heat recovery apparatus 12 has first piping 16 in which an exhaust gas from an engine 14 flows. In the following description, those simply referred to as “upstream” and “downstream” mean “upstream” and “downstream” in a flow direction (arrow F1 direction) of the exhaust gas.

A catalytic converter 15 that removes a specific component in the exhaust gas is disposed in the first piping 16. Second piping 18 branches from the first piping 16 in a branch portion 20 on a downstream side of the catalytic converter 15. The second piping 18 merges with the first piping 16 in a merging section 22 on a downstream side from the branch portion 20. A heat recovery unit 26 is disposed in the second piping 18. A part of the first piping 16 between the branch portion 20 and the merging section 22 is a bypass flow path 24 where the exhaust gas bypasses the heat recovery unit 26.

A coolant for the engine 14 circulates and is cooled, by circulation piping 28, between the engine 14 and a radiator 30. Recovery piping 32 branches from the circulation piping 28. A part of the coolant that flows in the circulation piping 28 is guided to the heat recovery unit 26 by the recovery piping 32 and, in addition, can return to the circulation piping 28 from the heat recovery unit 26. The coolant flows in the recovery piping 32 and the heat recovery unit 26, and thus the recovery piping 32 and the heat recovery unit 26 are flow paths for the coolant. In the example that is illustrated in FIG. 1, a heater 33 that heats the coolant is disposed in the recovery piping 32 if necessary.

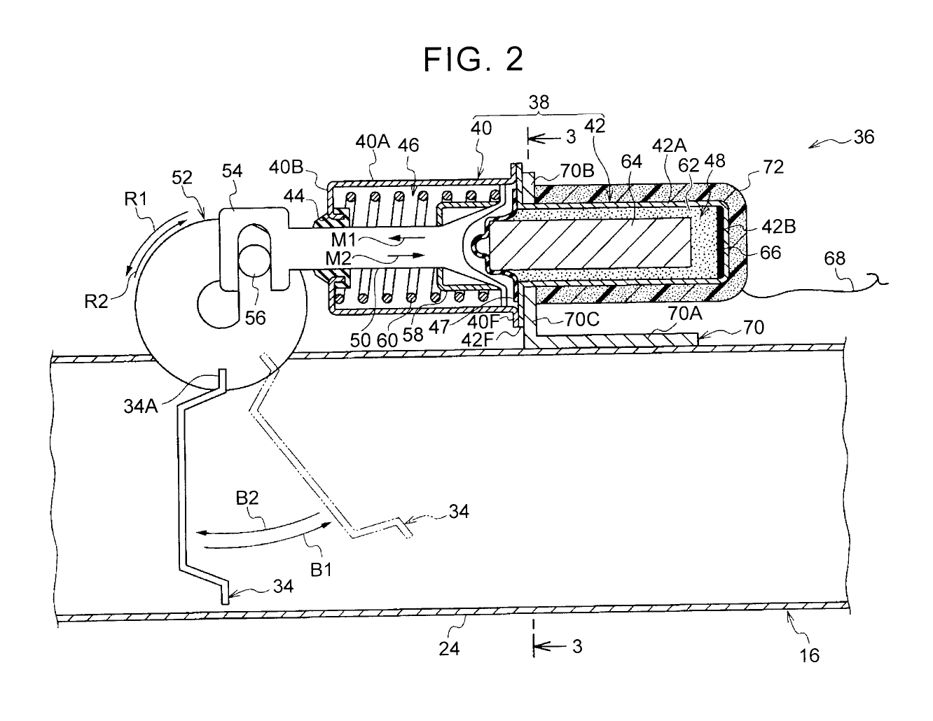

A valve member 34 is disposed in the bypass flow path 24 (position between the branch portion 20 and the merging section 22) of the first piping 16. The valve member 34 is controlled by an actuator 36 (described later) and is moved between a closed position that is illustrated by the solid lines in FIGS. 1 and 2 and an open position that is illustrated by the two-dot chain lines in FIGS. 1 and 2. At the closed position, the valve member 34 reduces a flow path cross-sectional area of the bypass flow path 24 (although the valve member 34 does not have to completely close the bypass flow path 24), and thus most of the exhaust gas flows to the second piping 18. At the open position, the valve member 34 allows the flow path cross-sectional area of the bypass flow path 24 to be larger than at the closed position, and thus the amount of the exhaust gas that flows in the second piping 18 is small.

The actuator 36 is mounted on the first piping 16 by a mounting tool (not illustrated) while being out of contact with the flow paths in which the engine coolant flows, that is, the recovery piping 32 and the heat recovery unit 26.

As illustrated in detail in FIG. 2, the actuator 36 has a housing main body 38 that is provided with a first housing 40 and a second housing 42. The first housing 40 has a tubular portion 40A and a bottom portion 40B (where an insertion hole 44 (described later) is formed) and has a cylindrical shape. Likewise, the second housing 42 has a tubular portion 42A and a bottom portion 42B and has a cylindrical shape. Respective flange portions 40F and 42F of the first housing 40 and the second housing 42 are bonded to constitute the housing main body 38 that forms a substantially cylindrical overall outer shape.

An inner portion of the housing main body 38 is partitioned into a first space 46 on the first housing 40 side and a second space 48 on the second housing 42 side by an elastic partition wall 47. A rod 50 that is capable of advancing from and retracting to the insertion hole 44 is accommodated in the first space 46.

A conversion disk 52 that rotates about a spindle 52A is arranged at a tip of the rod 50. A holding section 54 at one end of the rod 50 holds a holding pin 56 of the conversion disk 52.

A one end 34A side (upper side in FIG. 2) of the valve member 34 is fixed to the conversion disk 52. When the rod 50 is moved (advances) in an arrow M1 direction, the conversion disk 52 rotates in an arrow R1 direction and the valve member 34 is moved (pivots) to the open position as illustrated by arrow B1. In contrast, the conversion disk 52 rotates in an arrow R2 direction and the valve member 34 is moved (pivots) to the closed position as illustrated by arrow B2 when the rod 50 is moved (retracts) in an arrow M2 direction. In other words, the conversion disk 52 converts a linear motion of the rod 50 to a rotational motion (pivoting) of the valve member 34.

The other end of the rod 50 is mounted on a bracket 58. A spring 60 is accommodated between the bracket 58 and the bottom portion 40B of the first housing 40. The spring 60 biases the rod 50, via the bracket 58, in the arrow M2 direction (direction in which the rod 50 retracts into the first housing 40).

A moving pin 64 is accommodated in the second space 48 of the actuator 36 and the second space 48 of the actuator 36 is filled with wax 62. One end of the moving pin 64 is fixed to the elastic partition wall 47. A heating element 66 is accommodated in the second space 48. The heating element 66 generates heat when the heating element 66 is energized by a lead wire 68 for energization. The wax 62 is a liquid member that has a predetermined viscosity and the volume of the wax 62 increases as a result of temperature rise caused by heating. The elastic partition wall 47 allows the volume of the wax 62 to be changed and suppresses leakage of the wax 62 from the second space 48.

When the volume of the wax 62 increases, the elastic partition wall 47 extends slightly, the volume of the second space 48 increases, and the moving pin 64 is moved in the arrow M1 direction. Then, the moving pin 64 pushes the rod 50 in the arrow M1 direction via the elastic partition wall 47 and the rod 50 is moved in the arrow M1 direction.

In contrast, the elastic partition wall 47 shrinks slightly, the volume of the second space 48 decreases, and the moving pin 64 is moved in the arrow M2 direction when the volume of the wax 62 decreases. The moving pin 64 does not push the rod 50, and thus the rod 50 is moved in the arrow M2 direction by a force of the spring 60.

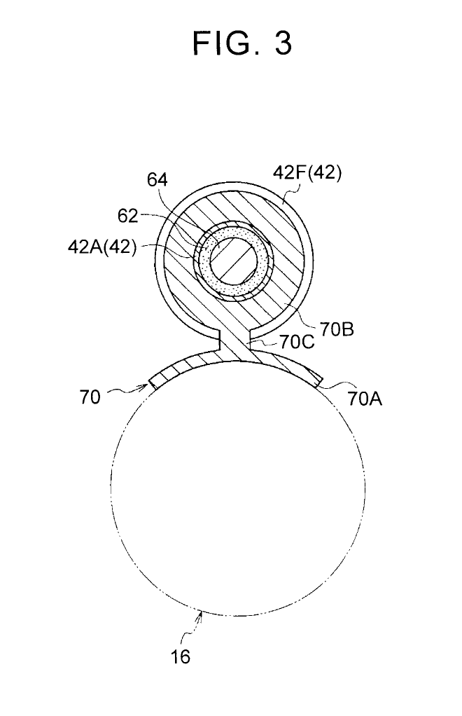

A heat conduction member 70 is mounted on the bypass flow path 24 of the first piping 16 and the actuator 36. As illustrated in detail in the drawings including FIG. 3, the heat conduction member 70 is a structure in which a partially cylindrical heat receiving portion 70A that is in contact with an outer circumference of the first piping 16 and an annular heat dissipating portion 70B that surrounds the tubular portion 40A of the second housing 42 are connected to each other by a connecting portion 70C.

The heat conduction member 70 is formed by using a material that has a high thermal conductivity such as a metal. The heat receiving portion 70A receives heat of the first piping 16 and the heat is dissipated from the heat dissipating portion 70B to the second housing 42. In this manner, the heat conduction member 70 transmits the heat of the exhaust gas to the wax 62.

In the example that is illustrated in FIG. 2, the heat receiving portion 70A is arranged to be in contact with the flange portion 42F of the second housing 42, and rattling of the heat receiving portion 70A against the second housing 42 is suppressed.

A heat insulation member 72 is arranged outside the tubular portion 40A and the bottom portion 40B of the second housing 42. In the example that is illustrated in FIGS. 2 and 3, the heat insulation member 72 avoids the heat dissipating portion 70B of the heat conduction member 70 but covers substantially an entire range of the tubular portion 40A and a substantially entire range of the bottom portion 40B. The heat insulation member 72 is formed by using, for example, a porous resin material and insulates the inside (wax 62) and the outside of the second space 48 from each other.

Next, an effect of this embodiment will be described.

The volume of the wax 62 increases in a state where the actuator 36 is energized. Accordingly, the moving pin 64 is moved in the arrow M1 direction and pushes the rod 50 in the arrow M1 direction. The rod 50 is moved (advances) in the arrow M1 direction against a biasing force of the spring 60, and thus the valve member 34 pivots to the open position.

In a state where the valve member 34 is at the open position, the flow path cross-sectional area of the bypass flow path 24 of the first piping 16 increases and a large amount of the exhaust gas flows in the bypass flow path 24. Accordingly, an effect of heating of the engine coolant for temperature rise by using the heat of the exhaust gas is small in the heat recovery unit 26.

In contrast, the wax 62 does not expand in a state where the actuator 36 is not energized. Accordingly, the moving pin 64 does not push the rod 50 in the arrow M1 direction. The rod 50 is moved (retracts) in the arrow M2 direction by the biasing force of the spring 60, and thus the valve member 34 is at the closed position.

In a state where the valve member 34 is at the closed position, the flow path cross-sectional area of the bypass flow path 24 of the first piping 16 is small and most of the exhaust gas flows to the second piping 18. In the heat recovery unit 26, the heat of the exhaust gas is allowed to act on the engine coolant, the engine coolant is heated, and a temperature rise effect is large. In a case where the engine coolant has a low temperature, for example, the engine coolant can be efficiently raised in temperature by energizing the actuator 36 and using the heat of the exhaust gas.

In this embodiment, the actuator 36 is arranged to be out of contact with the flow paths in which the engine coolant flows (the recovery piping 32 and the heat recovery unit 26). Compared to a structure in which the actuator 36 is in contact with the flow paths in which the engine coolant flows, the heat of the engine coolant has a smaller impact on the volume change (particularly, volume increase) of the wax 62. For example, non-recovery and recovery of the heat from the exhaust gas can be adjusted, not depending on the temperature of the engine coolant, by switching between energization and non-energization of the actuator 36 in any condition.

In addition, the actuator 36 is out of contact with the flow paths for the engine coolant in this embodiment, and thus the actuator 36 does not have to be waterproof against the engine coolant. The lack of necessity of a structure for waterproofing can contribute to weight reduction and cost reduction for the exhaust gas heat recovery apparatus 12. In addition, reliability and durability can be improved since no moisture is in contact with the actuator 36.

Particularly, the heat conduction member 70 is provided in this embodiment, and thus the heat of the first piping 16 can be allowed to act on the wax 62 via the heat conduction member 70. Accordingly, electric power consumption for energizing the actuator 36 can be suppressed in a case, for example, where a state where the volume of the wax 62 is increased is to be maintained.

A heat source for the heat that is allowed to act on the wax 62 by the heat conduction member 70 is not limited to the first piping 16 described above. In other words, a member that has high heat energy other than the first piping 16 can be used as the heat source. An exhaust gas pipe such as the first piping 16 is a member that is provided in advance in a vehicle, and thus the heat of the exhaust gas flowing in the first piping can be efficiently transferred to the wax 62 without having to add a new member as the heat source.

The heat that is received from the exhaust gas can be allowed to act on the wax 62, even if the heat conduction member 70 is a structure that has the heat dissipating portion 70B which surrounds the wax 62 outside the second housing 42 and does not surround the wax 62, insofar as, for example, the heat conduction member 70 is in contact with the second housing 42. If the heat dissipating portion 70B surrounds the wax 62 as in the embodiment described above, the heat can be efficiently transferred to the wax 62.

In this embodiment, the valve member 34 is at the open position as illustrated by the two-dot chain line in FIG. 2 and a flow rate of the exhaust gas to the second piping 18 is low in a state where the temperature of the wax 62 increases. In other words, heating of the wax 62 can be supplemented by the heat of the first piping 16 in a state where the amount of heat recovered by the heat recovery unit 26 is small (state where the valve member 34 is maintained at the open position), and the valve member 34 can be efficiently maintained at the open position. This can contribute to suppressing the electric power consumption by the actuator 36.

In addition, the heat insulation member 72 is provided in this embodiment. The wax 62 is insulated from the outside by the heat insulation member 72, and thus an impact of external heat on the volume change of the wax 62 is small. For example, the impact of the heat from the first piping 16, the second piping 18, the heat recovery unit 26, and the like is small.

Except for the heat conduction member 70, air is present around the actuator 36, particularly around the heat insulation member 72. The air is lower in thermal conductivity than water. Accordingly, the temperature of the wax 62 can be raised within a shorter period of time than in a structure in which the actuator 36 is in contact with the engine coolant, and the rod 50 can be moved faster and a larger amount of the movement can be ensured at the same electric power input amount.

Since the temperature of the wax 62 is maintained by the heat insulation member 72, electric power consumption can be reduced when the actuator 36 is energized to increase the volume of the wax 62.

In addition, the second housing 42 can be protected from foreign matters and shocks since the wax 62 is positioned around the second housing 42. From the viewpoint of protection from the external foreign matters and shocks described above, the heat insulation member 72 may be arranged to also cover, for example, the vicinity of the first housing 40.

A heat medium is not limited to the engine coolant, and a wide range of fluids facilitating heat exchange, such as liquids and gases, can also be applied. The exhaust gas heat can be allowed to act on the heat medium by the exhaust gas heat recovery apparatus 12 according to this embodiment so that the temperature rise can be performed.

The actuator 36 described above is a structure that allows the sealed space (second space 48) in the housing main body 38 to be sealed with the wax 62 and the moving pin 64 to be moved by the expansion of the wax caused by heating. Since the volume change of the wax 62 (liquid) is used for a driving force for the valve member 34 as described above, a larger driving force can be obtained than in, for example, a structure using a motor and a structure obtaining a driving force from gas volume change in a sealed space (so-called negative pressure actuator).

Even if a large force acts from the exhaust gas in an opening direction of the valve member 34 (arrow B1 direction in FIG. 2), the valve member 34 can be allowed to pivot in a closing direction (arrow B2 direction in FIG. 2) against this force and the valve member 34 can be held at the closed position against this force. Accordingly, the shape and the arrangement of the valve member 34 have a high degree of freedom. A so-called swing valve, in which a pivot center is set in an end portion (spindle 52A) of the valve member 34 as illustrated in FIG. 2, can be adopted as the structure of the valve member 34. Also, a so-called butterfly valve, in which the pivot center is set at the center of the valve member 34 as in this embodiment, can be adopted.

In the actuator having the structure in which the moving pin is moved by the expansion of the wax caused by heating, the moving pin may be moved much even in a case where an unintended temperature change acts on the wax. In this embodiment, the actuator 36 is out of contact with the flow paths (the recovery piping 32 and the heat recovery unit 26) in which the engine coolant flows, and thus the impact of the heat of the engine coolant on the volume change of the wax 62 is small. Accordingly, a careless movement of the moving pin 64 and unintended pivoting of the valve member 34 can be suppressed, and a structure in which the pivoting of the valve member 34 is ensured to be controlled by the energization of the actuator 36 can be obtained.

What is claimed is:

1. An exhaust gas heat recovery apparatus comprising:
first piping in which an exhaust gas from an engine flows;
second piping branching from the first piping and including a heat recovery unit allowing heat of the exhaust gas to act on a heat medium;
a valve member that adjusts a flow rate of the exhaust gas to the second piping; and
a driving member arranged to be out of contact with a flow path for the heat medium and energized to heat wax to change a volume of the wax so that the valve member is driven.

2. The exhaust gas heat recovery apparatus according to claim 1, further comprising:
a heat conduction member that transfers heat from a heat source to the wax.

3. The exhaust gas heat recovery apparatus according to claim 2,
wherein the heat source is the first piping.

4. The exhaust gas heat recovery apparatus according to claim 2,
wherein the heat conduction member includes a surrounding portion surrounding the wax.

5. The exhaust gas heat recovery apparatus according to claim 2,
wherein the driving member is configured to control the valve member so that a temperature rise of the wax decreases the flow rate of the exhaust gas to the second piping.

6. The exhaust gas heat recovery apparatus according to claim 1, further comprising:
a heat insulation member that insulates the wax from an outside of the wax.

7. The exhaust gas heat recovery apparatus according to claim 1,
wherein the valve member is disposed in the first piping.
